(19) United States
(12) Patent Application Publication
(10) Pub. No.: US 2015/0277144 A1
(43) Pub. Date: Oct. 1, 2015

(54) PRODUCTION OF OPTHTHALMIC LENSES WITH PROTECTED MICROSTRUCTURES

(71) Applicant: RODENSTOCK GMBH, München (DE)

(72) Inventors: Stephan Trumm, Muenchen (DE); Herbert Schuster, Emmering (DE); Reiner Beck, Bayreuth (DE); Werner Mueller, Oetisheim (DE)

(21) Appl. No.: 14/432,394

(22) PCT Filed: Oct. 16, 2013
(86) PCT No.: PCT/EP2013/003111

§ 371 Date: Mar. 30, 2015

(30) Foreign Application Priority Data
Oct. 17, 2012 (DE) 10 2012 020 452.3

(51) Int. Cl. G02C 7/02; G02B 3/00

(52) U.S. Cl. CPC G02C 7/022; G02B 3/00

(57) ABSTRACT

A method for preparing ophthalmic lenses, which have a microstructure on at least one side, particularly a diffractive microstructure for colour fringe correction, wherein the invention provides in particular a method which substantially reduces any adverse effect on the microstructure by damage or soiling during the manufacture of an ophthalmic lens and during the use thereof. Thus a method according to the invention for manufacturing an ophthalmic lens comprises provision of a microstructure on at least one first surface of an ophthalmic lens glass and application of at least one protective coating on the ophthalmic lens glass in such a manner that the protective coating at least partially covers the microstructure, wherein the protective coating has a refractive index which differs from the refractive index of the ophthalmic lens glass.

The present invention relates to a method for providing spectacle lenses which have a microstructure on at least one side, particularly a diffractive microstructure for color fringe correction, wherein the invention provides in particular a method which substantially reduces any adverse effect on the microstructure by damage or soiling during the manufacture of a spectacle lens and during the use thereof.

A spectacle lens which has a refractive front surface and a refractive back surface and which is composed of a dispersing material always generates a color fringe in the periphery. This applies irrespective of the monochromatic criteria according to which the spectacle lens surfaces have initially been determined. In particular, if due to an individual optimization, the surfaces implement the best possible compromise between different needs in monochromatic terms, as this is accomplished, e.g., by minimization of a target function, then a lens with these surfaces has a color fringe under polychromatic conditions. This color fringe can be compensated at least partially by using a diffraction grating. Some examples of a design of diffractive structures for color fringe correction in spectacle lenses are known, for example, from DE 10 2010 051 627 A1, DE 10 2010 051 637 A1, DE 10 2010 051 645 A1 and DE 10 2010 051 762 A1.

Such microstructures are often very sensitive due to their dimensions (typically 0.3-5 μm axially, 1-500 μm laterally) and are easily impaired in terms of their optical effect by soiling and/or damage (scratching). The latter applies in particular if the structure is applied, on organic materials which are comparatively easily deformable by application of mechanical force. In order to keep undesirable adverse effects on the microstructures, in particular damage thereto, as low as possible, at least during a manufacturing process of the spectacle lens, in the overall manufacturing process one could try to shift the formation of the microstructures as far as possible toward the end of the process. One could also try to carry out as many processing steps as possible before generating the microstructures. However, in this case, generating the microstructures is limited to special technologies. For example, this would mean that the microstructures could no longer already be generated in a casting process for the manufacture of a spectable lens blank.

It is therefore an object of the present invention to reduce any adverse effect, in particular on diffractive microstructures in spectacle lenses, by damage or soiling.

This object is achieved by a method and a spectacle lens having the features disclosed in claim 1 and claim 8, respectively. Preferred embodiments are the subject matter of the dependent claims.

Thus, the invention provides a method for manufacturing a spectacle lens. In the process of this, a microstructure is first provided on at least one first surface, in particular the front surface, of a spectacle lens or a spectacle lens body. This microstructure serves in particular as a diffraction grating for visible light, preferably for color fringe correction in the spectacle lens. Moreover, the method comprises applying at least one protective coating or layer on the spectacle lens body, in particular on the first surface of the spectacle lens body, in such a manner that the protective coating or layer covers the microstructure at least partially, wherein the protective coating or layer has a refractive index which differs from the refractive index of the spectacle lens body.

In this manner it is prevented by means of the protective coating that the microstructure (in particular in the form of a diffraction grating) formed in the spectacle lens, thus on the first surface of the spectacle lens body, is damaged by subsequent process steps of the spectacle lens manufacture or is contaminated during these processes. Due to the difference in the refractive index, the microstructure remains optically effective; in particular, the microstructure can act as a diffraction grating (in particular for visible light). In particular, the protective coating is provided with, sufficient optical transparency to avoid excessively impairing the use of the spectacle lens including the protective coating. Thus, the protective coating can remain on the spectacle lens and. therefore can also protect the microstructure against damage and soiling, for example, during subsequent work steps at the optometrist (e.g. edging the spectacle lenses) and when wearing the finished, eyeglasses. For this purpose, the protective coating has a largely smooth. surface on the side of the protective coating facing away from the microstructure, which smooth surface in particular does not follow the topography of the microstructure, but merely follows the overall curvature of the spectacle lens. This substantially smooth surface of the protective coating is therefore significantly less sensitive to damage or soiling. Moreover, this provides the possibility to apply in a simple manner additional coatings (e.g., anti-reflection coatings, top coatings, hard coatings), which could not be (readily) applied on the non-flat surface of the microstructure or could negatively influence the effect thereof.

Thus, the invention provides a method for solving a complex production task, which method is technically less complicated and is particularly economical. In particular, when implementing the method according to the invention by means of a protective coating, technologically and economically very efficient processes can be used even for generating the microstructures without having to worry about damaging or soiling the microstructures. Thus, for example, the microstructures can already be generated during casting of the spectacle lenses or spectacle lens blanks by already providing at least one casting mold with corresponding (negative) microstructures, for example. Although this is a very early stage in the manufacture of spectacle lenses and the spectacle lens normally is still subjected to a multiplicity of further process steps, the protective coating applied on the microstructure preferably shortly or immediately after casting ensures permanent protection of the microstructure against damage or soiling. This advantage becomes particularly apparent when applying process steps in which high forces, sharp edges, high temperatures or aggressive chemicals act on the spectacle lens to be manufactured, or if the structure could be exposed to soiling (e.g., dust). Prominent examples of such are blocking, cutting, grinding or polishing-, shaping the edges and refinement steps. Moreover, the protective coating protects the microstructure during processing of the spectacle lens by the optometrist—in particular during grinding and. the blocking necessary for this.

Thermosetting materials (e.g., Perfalit 1.67) are widely used as basic materials for spectacle lenses. This class of polymers resists subsequent (thermal) deformation in the vast majority of cases. For many process flows, it is therefore necessary to already introduce a desired microstructure during polymerization of the blank or the spectacle lens by casting a structured molding. Accordingly, microstructuring naturally comes first in the process chain, so that the structure is inevitably subjected to the aforementioned “aggressive” subsequent operations or environments. Specifically in these cases, the invention provides a very effective and economically efficient solution by applying the protective coating after microstructuring and prior to the “aggressive” processing steps or subjecting to such environments.

This protective coating not only serves for protecting the structure during manufacturing (up to completion of the finished eyeglasses), but as an integral part of the spectacle lens, it also serves for the protection of the product during use by the wearer of the eyeglasses.

The protective coating and the optical properties thereof—in particular the refractive index—are already taken into account during the design of the microstructure. A difference between the refractive index of the protective coating and the refractive index of the spectacle lens body (for visible light) is preferably at least approximately 0.05, preferably at least approximately 0.1, more preferably at least approximately 0.15 and most preferably at least approximately 0.2. Thus, for example, the spectacle lens body could have a refractive index of approximately 1.6, whereas the protective coating is provided with a refractive index of approximately 1.5. In another example, the refractive index of the spectacle lens body could be approximately 1.67, whereas the protective coating is provided with a refractive index of approximately 1.6. In order to achieve a greater difference in the refractive index, the spectacle lens body could have, for example, a refractive index of 1.67, whereas the protective coating is provided with a refractive index of 1.5. For an even greater difference in the refractive index, an exemplary combination with a refractive index of approximately 1.74 for the spectacle lens body and approximately 1.5 for the protective coating is also possible.

Furthermore, it is preferred if the material of the protective coating is optically clear and—unless otherwise desired—is uniformly transparent in the visible range of light. The protective coating itself does not have to be particularly hard, since an additional hard coating can be applied; however, it preferably should nevertheless ensure sufficient adhesive strength and wear resistance for further processing. Furthermore, the material of the protective coating or the condition of the surface thereof is preferably selected such that it adheres to the volume material and—if desired—that further well-adhering coatings can be applied on the protective coating.

While the protective coating on the surface facing the spectacle lens body follows the topography of the micro-structure, this microstructure is preferably not reproduced on the side of the protective coating that faces away from the spectacle lens body.

The surface of the protective coating facing away from the spectacle lens body preferably has a geometry in which the protective coating substantially follows (particularly preferably equidistantly) the shape of the corresponding surface of the spectacle lens (thus, for example, a spherical surface, an a spherical but rotationally symmetrical surface, or a freeform surface) without reproducing the structure. Furthermore, on the side facing away from the microstructure, a smooth protective coating or a coating that meets special requirements (e.g., defined roughnesses for improving adhesion of the subsequent coating) is preferred.

The thickness of the coating is preferably selected such that it is greater than the wavelength of the light used. However, if other (optical) effects are to be achieved by the microstructure (e.g., generating an effective refractive index), the thickness can be designed according to these requirements. The protective coating particularly preferably has a thickness of at least approximately 5 μm, preferably at least approximately 20 μm, particularly preferably at least approximately 100 μm, most preferably at least approximately 200 μm. Thus, in particular interference phenomena (mainly Fabry-Perot interferences) within the protective coating are effectively suppressed or prevented. This can be explained by the fact that for these coating thicknesses, the typical coherence length of the usual ambient light becomes (at least partially) shorter than the coating thickness, as a result of which interference effects become negligible.

The protective coating is applied at least on the microstructured side of the spectacle lens or the blank. For this purpose, different process technologies can be used.

In a preferred embodiment, the protective coating is cast on the microstructure (so-called “compound process”). In this manner, comparatively thick coatings can be achieved as well as coatings having a defined thickness. By a suitable configuration of the casting mold, it is also possible in a simple manner to produce protective coatings, the surfaces of which, have defined shapes (geometry) and structures (e.g. roughnesses).

According to another preferred embodiment of the invention, a less complex solution for manufacturing the protective coating is a single or multiple immersion process. If coating the side facing away from the structure is not desired (e.g., with regard to subsequent processes) and if immersion baths are used, this side can be protected accordingly (for example by “masking”), or the coating can be removed from this side at a later time.

In another preferred embodiment, the process of single or multiple spinning, which is common, in particular in the field of photolithography, is used for producing the protective coating.

Another preferred embodiment utilizes a sputtering process for producing the protective coating. This process is particularly suitable mainly for specific coating materials (e.g., quartz).

Further preferred embodiments also use spray coating (spraying) and/or floating (flow coating).

As already explained, the present invention enables implementation of a variety of different, methods for preparing the desired microstructures without having to worry about any subsequent adverse effect on the microstructure. Thus, in a preferred embodiment, preparing the microstructure is carried out by casting (even injection molding) the microstructure, in particular during polymerization of the volume material (thus, the spectacle lens body), during the manufacture of the blank or spectacle lens. However, casting methods in which the polymer is already polymerized, e.g., injection molding of PC and PMMA, are particularly preferably used.

However, when using other technologies, it can also be advantageous to carry out the structuring step prior to other steps (e.g., cutting or refining), even if this, unlike with molding, does a priori not appear to be absolutely necessary. An example for this is the forming process which, due to the required forces or temperatures, can have an adverse effect on an already processed surface (e.g., “prescription lens surface”). For some surfaces (in particular PAL or freeform surface), holding the lens/blank for structuring can be difficult because the surface to be fixed is uneven.

A forming process in this context is to be understood in particular as an embossing or punching process which creates the microstructure on the surface to be structured of the spectacle lens body by applying pressure thereon by means of a microstructured punch. The required deformation of the surface of the spectacle lens body can be facilitated by additional influence of increased temperature. In another preferred embodiment, manufacturing the microstructure in the first surface of the spectacle lens is carried out mechanically by machining, e.g. by diamond, milling. In a further preferred embodiment, the microstructure is incorporated into the blank or the spectacle lens (into the first surface of the spectacle lens body) by laser ablation. The structure can be smoothed in a second process. This preferably takes place by fusion by means of laser systems.

In particular in the case of individually produced, spectacle lenses, the back surface of the spectacle lens is preferably calculated individually and is preferably machined by milling and/or grinding and/or polishing to achieve the individually calculated and optimized surface effect. When using the present invention, such machining steps of a second, surface of the spectacle lens body are preferably carried out after applying the protective coating, which therefore protects the preferably already previously produced microstructure during the later processing steps. Thus, after applying the protective coating, the method, preferably also comprises mechanical machining of a second surface (in particular the back surface) of the spectacle lens (i.e., the spectacle lens body) which faces away from the first surface. In this step, the side facing away from the microstructure is provided with the desired surface geometry. This step can also be omitted if the side facing away from the microstructure requires no further processing. This is the case, for example, if this surface as well is already provided with the desired geometry after casting.

If mechanical machining of the second surface is desired, techniques such as milling-grinding-polishing (traditional RGF) or “cut to polish” are preferably used here. For this purpose, the blank is usually blocked. Mechanical machining of the second surface thus preferably comprises fastening a holding element (so-called block) on the first surface of the spectacle lens or on the protective coating. Subsequently, the second surface is mechanically machined while the spectacle lens is held or manipulated (thus moved in a controlled manner) by means of the holding element. In order to fasten the holding element on the first surface of the spectacle lens or on the protective coating, adhesive films or special lacquer layers in combination with low-melting metal alloys can be used. When selecting the adhesive or the lacquer, it should be ensured, that, on the one hand, the adhesive or the lacquer adheres with sufficient strength to the protective coating so as to securely hold the blank and, on the other hand, the blank can be detached, therefrom after machining without destroying the protective coating.

After machining the second, surface, the holding element is preferably removed from the first surface of the spectacle lens or from the protective coating, wherein the protective coating is substantially maintained on the spectacle lens body (deblocking). After deblocking and prior to further processing, the protective coating is preferably cleaned and/or smoothed. However, in other preferred embodiments, the spectacle lens or the spectacle lens blank initially remains blocked in order to carry out further machining steps. This is particularly advantageous if complicated, repositioning of the lens can be dispensed with in this way. The manufacturing method preferably also comprises edging the spectacle lens. During this step as well, the protective coating preferably remains on the first surface. The spectacle lens blank or the spectacle lens can also remain blocked, for this step.

After applying the protective coating, the method preferably comprises depositing a further functional coating, in particular an adhesive coating and/or a hard coating and/or an anti-reflection coating and/or a hydrophobic and/or lipophobic coating (water- and/or dirt-repellent) and/or a coloring coating. This further functional coating is preferably at least partially deposited on the protective coating.

In a further aspect, the invention provides a spectacle lens which is manufactured in particular according to a method according to the invention, the spectacle lens comprising:
a spectacle lens body having a microstructure on at least one first surface of the spectacle lens body; and
a protective coating which is arranged on the spectacle lens body and which covers the microstructure at least partially, wherein the protective coating has a refractive index which differs from the refractive index of the spectacle lens body. In this way, as already explained above, a desired microstructure is protected in a very efficient manner against any adverse effects caused by damage and/or soiling.

Preferably, a difference between the refractive index of the protective coating and the refractive index of the spectacle lens body is at least approximately 0.05, preferably at least approximately 0.1, more preferably at least approximately 0.15 and most preferably at least approximately 0.2.

Preferably, the protective coating has a thickness of at least approximately 5 μm, preferably at least, approximately 20 μm, particularly preferably at least approximately 100 μm and most preferably at least approximately 200 μm. Thus, in particular interference phenomena (mainly Fabry-Perot interferences) within the protective coating are effectively suppressed or prevented. This can be explained by the fact that for these coating thicknesses, the typical coherence length of the usual ambient light becomes (at least in part) shorter than the coating thickness, as a result of which interference effects become negligible.

The spectacle lens also preferably comprises a further functional coating, in particular an adhesive coating and/or a hard coating and/or an anti-reflection coating and/or a hydrophobic coating (water- and/or dirt-repellent) and/or a coloring coating.

Hereinafter, specific examples of preferred materials for the spectacle lens body and for the protective coating are specified. For the spectacle lens body, thus, the main component of the spectacle lens, which is obtained, from a spectacle lens blank, in particular the following materials are suitable:
Perfalit 1.5
   chemical designation: polyethylene glycol bis(allyl carbonate)
   basis is CR 39 (Columbia Resin 39) from PPG
   refractive index 1.5; Abbe number 58
   thermoset
PCM 1.54 (Photochrome)
   chemical designation: copolymers containing, among others, polyethylene glycol dimethacrylate,
   refractive index 1.54; Abbe number 43
   thermoset
Polycarbonate
   refractive index 1.59; Abbe number 29
   absolutely unbreakable! (sports and children's sector)
   poor solvent resistance (alcohol, acetone)
   thermoset
Perfalit 1.6
   chemical designation: polythiourethane
   refractive index 1.60; Abbe number 41
   thermoset
Perfalit 1.67
   chemical designation: polythiourethane
   refractive index 1.67; Abbe number 32
   thermoset
Perfalit/Cosmolit 1.74
   chemical designation: polyapisulfide
   refractive index 1.74; Abbe number approximately 32
   thermoset

In particular in connection with one or more of the above-mentioned preferred materials of the spectacle lens body, one or more of the following materials are preferably used for the protective coating:
TS56T from Tokuyama:
This lacquer having a refractive index of 1.49 is used for conventional spectacle lenses, preferably for Perfalit 1.5. Through an immersion process, thicknesses of about 2.2 μm are preferably obtained.
IM-9200 from SDC Technologies:
This lacquer has a refractive power between 1.585 and 1.605 and, in the case of conventional spectacle lenses, is applied on Perfalit 1.6 and 1.67, preferably after a surface activation. Through immersion processes, thicknesses of about 2.8 μm are preferably achieved. Variations of from 1.5 μm to 3.2 μm are possible.
Transhade from Tokuyama:
This is preferably a photochromic lacquer system. A primer (Transhade-SC-P) as a bonding agent, is preferably applied on the spectacle lens body (Perfalit 1.6 or 1.67), and subsequently, the photochromic photoresist (Transhade-SC-L4 Brown or Gray) having a refractive index in the range of from 1.50 to 1.55 is applied and preferably covered by a. hard, lacquer coating. Thicknesses between 30 μm and 50 μm are preferably achieved by means of spin coating. Typical thicknesses are approximately 39 μm. Moreover, casting processes by means of which thicknesses of more than 200 μm can be achieved, could also be used. This lacquer is also available without photochromic colorings, and can be cured thermally and also by UV irradiation.
Hi Guard 1080 from PPG and Products from Tokuyama
These lacquers could be used an alternative to TS56T (3) from Tokuyama for applying on Perfalit 1.5.
Fused Quartz

In a preferred embodiment, fused quartz is vapor-deposited as a hard coating onto Perfalit 1.5. In doing so, coating thicknesses of up to 3 μm are preferably achieved. This coating can also be applied on Perfalit 1.6 and 1.67. However, the coating does not adhere directly to these highly refractive materials, for which reason an intermediate coating of hard lacquer is preferably used.

It is particularly preferred to apply a protective coating having a refractive index as low as possible (low refractive index n_{S}) on lenses having a refractive index as high, as possible (high refractive index of the spectacle lens body n_{K} in particular including the microstructure). A refractive index jump that is as high as possible is thereby achieved. Preferred combinations are, for example, n_{S}=1.5 on n_{K}=1.6 or on n_{K}=1.67 or on n_{K}=1.74, etc., but also n_{S}=1.6 on n_{K}=1.67 or on n_{K}=1.74, etc., but also n_{S}=1.67 on n_{K}=1.74, etc. Particularly preferred are combinations having an even higher difference in the refractive index, in particular at least 0.2 or higher.

The invention is described hereinafter by means of preferred embodiments with, reference to the accompanying drawings. In the figures:

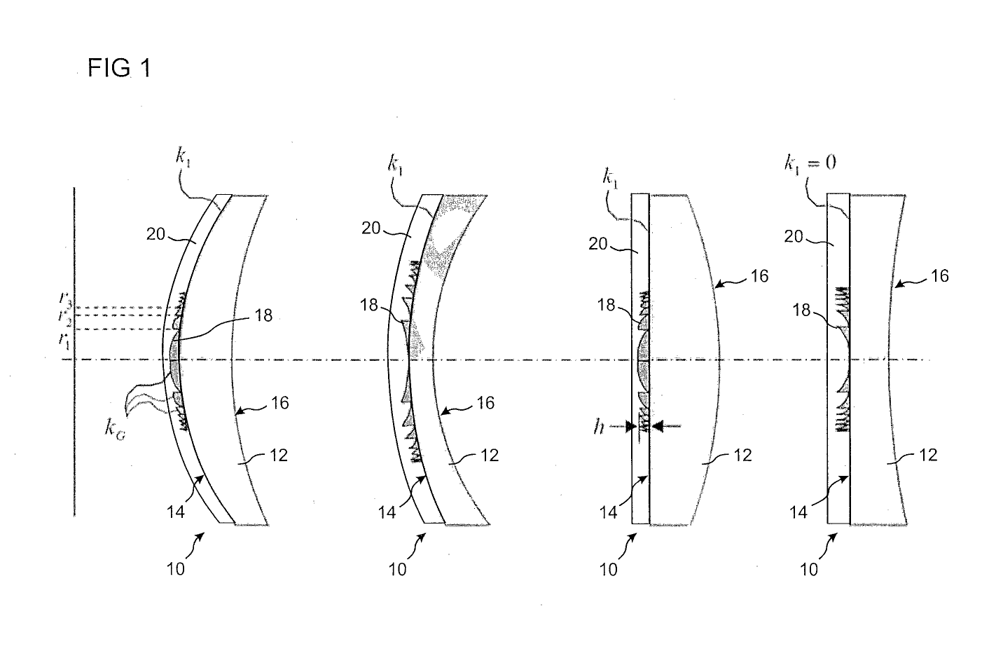

FIG. 1 shows schematic illustrations of spectacle lenses or spectacle lens blanks having a diffractive microstructure on a first surface according to preferred embodiments of the present invention; and

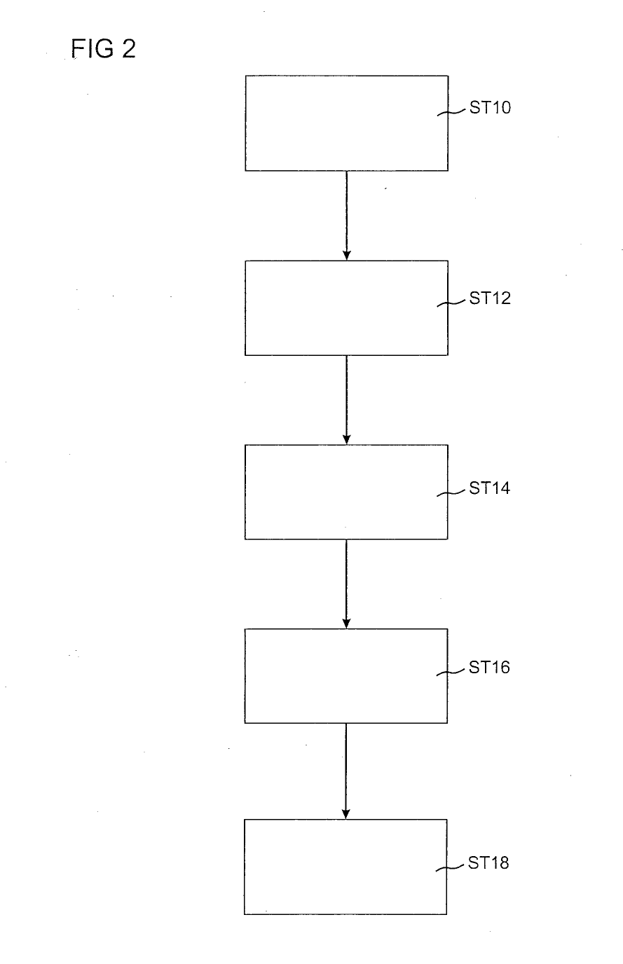

FIG. 2 shows a schematic illustration of individual method steps in a manufacturing method according to a preferred embodiment of the present invention.

FIG. 1 illustrates examples of spectacle lenses 10 exhibiting different effects and surface curvatures. A spectacle lens body 12 has in each case a front surface 14 and a back, surface 16 (eye-side surface). A diffractive microstructure 18 is formed in each case on the front surface 14. The illustration of the diffractive microstructure 18 is to be regarded as purely schematic. In particular, the respective microstructure 18 is not illustrated true to scale. Usually, the microstructure 18 is significantly smaller compared with the spectacle lens body 12. Typical dimensions of diffractive microstructures preferably range from approximately 0.3 to 5 μm in the axial direction (thus, in the thickness direction, of the spectacle lens) and from approximately 1 to 500 μm in the lateral direction. From left to right. FIG. 1 successively shows as an example a plus lens having a convex base curvature (front surface 14), a minus lens having a convex base curvature (front surface 14), a plus lens having a planar base curvature (front surface 14) and a minus lens having a planar base curvature (front surface 14).

Moreover, a spectacle lens 10 in the illustrated, preferred embodiment also has a protective coating 20 on the front surface 14 of the spectacle lens body 12. As for the microstructure 18, the protective coating 20 in FIG. 1 is not illustrated true to scale. The protective coating is preferably significantly thinner than the spectacle lens body. Thus, the protective coating 20 is preferably thinner than approximately 1 mm, more preferably not thicker than approximately 0.5 mm and more particularly preferably not thicker than approximately 0.2 mm. In some preferred embodiments, the protective coating is not thicker than approximately 0.1 mm or not thicker than even approximately 50 μm. However, the protective coating is preferably at least thick enough that it covers the microstructure 18 on the front surface 14 (first surface of the spectacle lens body) and therefore protects the microstructure against damage and soiling.

During the spectacle lens manufacture, the protective coating is preferably applied shortly or immediately after preparing the microstructure 18, and remains on the spectacle lens body 12 during the entire further processing of the spectacle lens blank up to the finished spectacle lens, in particular up to the finished eyeglasses, and covers and thus protects the microstructure 18.

FIG. 2 schematically illustrates a corresponding method for manufacturing a spectacle lens according to a preferred embodiment of the invention. In this preferred embodiment, first, a spectacle lens body (spectacle lens blank) having a diffractive microstructure on at least one surface, preferably the front surface, is provided in a step ST10. Preparing the microstructure is preferably carried out using one of the above-described methods (e.g., during casting of the spectacle lens blank and/or by means of an embossing/punching method and/or by milling, etc.).

In a further step ST12, a protective coating is then applied at least on the first surface in such a manner that the protective coating preferably covers the microstructure completely. The protective coating has a refractive index which differs from the refractive index of the spectacle lens body, preferably at least by approximately 0.05. The refractive index of the protective coating is particularly preferably less than the refractive index of the spectacle lens body. The protective coating is preferably applied using one of the above-described methods (e.g., by means of an immersion process and/or by spinning and/or by sputtering and/or by spraying and/or by floating, etc.).

In the preferred embodiment illustrated in FIG. 2, the method also comprises a step ST14 of mechanically machining a second surface of the spectacle lens body, in particular the back surface, which faces away from the microstructure. This is advantageous primarily for individually manufactured spectacle lenses. Such machining steps comprise in particular milling and/or grinding and/or polishing the back surface of a spectacle lens, in particular of an individually manufactured progressive lens. For this purpose, a holding element (block) is preferably fastened on the first surface of the spectacle lens or on the protective coating to allow the spectacle lens blank to be precisely held or manipulated. In particular after completion of all machining steps for which the block is used, the block is removed, wherein the protective coating on the first surface of the spectacle lens remains intact.

The preferred method illustrated in FIG. 2 also comprises a step ST16 of refining the spectacle lens, in particular by depositing one or more further functional coatings, in particular a hard coating and/or an adhesive coating and/or an AR coating and/or a hydrophobic and/or lipophobic coating and/or a coloring coating. If this (these) further coating (s) is (are) to be deposited only on. the back surface (second surface) of the spectacle lens, this can also be carried as long as the spectacle lens blank is still blocked. However, if further coating of the front surface is to be carried out, this further coating is preferably applied directly or indirectly on the protective coating.

Lastly, according to a particularly preferred embodiment of the invention, the method illustrated in FIG. 2 also comprises a step ST18 of edging the spectacle lens, wherein the protective coating preferably also remains intact during this step, which, for example, is carried, out by the optometrist, and also during the subsequent assembling of the spectacle lens in the frame and when wearing the eyeglasses.

### REFERENCE LIST

10 spectacle lens (blank)
12 spectacle lens body
14 front surface (base curvature) of the spectacle lens
16 back surface of the spectacle lens
18 microstructure
20 protective coating

1. A method for manufacturing a spectacle lens, comprising:
providing a microstructure on at least one first surface of a spectacle lens body; and
applying at least one protective coating on the spectacle lens body in such a manner that the protective coaling at least partially covers the microstructure, wherein the protective coating has a refractive index which differs from the refractive index of the spectacle lens body.

2. The method according to claim 1, wherein the protective coating is applied by casting and/or by a single or multiple immersion process and/or by single or multiple spinning and/or by sputtering and/or spraying and/or by flow coating.

3. The method according to claim 1, wherein the microstructure on the first surface of the spectacle lens body is prepared
by casting the microstructure during the production of the spectacle lens body; and/or
by forming the first surface by means of a punch; and/or
by a machining method; and/or
by laser ablation.

4. The method according to claim 1, which method, after applying the protective coating, also comprises mechanically machining a second surface of the spectacle lens, which second surface faces away from the first surface.

5. The method according to claim 4, wherein the mechanical machining of the second surface comprises:
fastening a holding element on the first surface of the spectacle lens or the protective coating;
mechanically machining the second surface while the spectacle lens is held or manipulated by means of the holding element; and
removing the holding element from the first surface of the spectacle lens or from the protective coating, wherein the protective coating remains substantially intact on the spectacle lens.

6. The method according to claim 5, further comprising cleaning and/or smoothing of the protective coating after removing the holding element.

7. The method according to claim 1, further comprising after applying the protective coating, depositing an adhesive coating and/or a hard coating and/or an anti-reflection coating and/or a hydrophobic and/or lipophobic coating and/or a coloring coating.

8. A spectacle lens, comprising:
a spectacle lens body having a microstructure on at least one first surface of the spectacle lens body; and
a protective coating which is arranged on the spectacle lens body and which covers the microstructure at least partially, wherein the protective coating has a refractive index that differs from the refractive index of the spectacle lens body.

9. The spectacle lens according to claim 8, wherein a difference between the refractive index of the protective coating and the refractive index of the spectacle lens body is at least approximately 0.05.

10. The spectacle lens according to claim 8, wherein the protective coating has a thickness of at least approximately 5 μm.

11. The spectacle lens according to claim 8, wherein a difference between the refractive index of the protective coating and the refractive index of the spectacle lens body is at least approximately 0.1.

12. The spectacle lens according to claim 8, wherein a difference between the refractive index of the protective coating and the refractive index of the spectacle lens body is at least 0.15.

13. The spectacle lens according to claim 8, wherein a difference between the refractive index of the protective coating and the refractive index of the spectacle lens body is at least approximately 0.2.

14. The spectacle lens according to claim 8, wherein the protective coating has a thickness of at least approximately 20 μm.

15. The spectacle lens according to claim 8, wherein the protective coating has a thickness of at least approximately 100 μm.

16. The spectacle lens according to claim 8, wherein the protective coating has a thickness of at least approximately 200 μm.
